(19) United States
(12) Patent Application Publication
(10) Pub. No.: US 2012/0096015 A1
(43) Pub. Date: Apr. 19, 2012

(54) SYSTEM AND METHOD FOR ASSISTING A USER TO SELECT THE CONTEXT OF A SEARCH QUERY

(75) Inventors: GEORGE PAULOSE KOOMULLIL, BANGALORE (IN); HARIHARAN RAMASANGU, BANGALORE (IN); AMRITA LAKSHMI, BANGALORE (IN); NIKHIL CHHAOCHHARIA, BANGALORE (IN)

(73) Assignee: INDUS TECHINNOVATIONS LLP, BANGALORE (IN)

(21) Appl. No.: 13/252,556

(22) Filed: Oct. 4, 2011

(30) Foreign Application Priority Data
Oct. 13, 2010 (IN) 3028/CHE/2010

(51) Int. Cl. G06F 17/30

(52) U.S. Cl. 707/749; 707/736; 707/E17.008; 707/E17.018; 707/E17.062

(57) ABSTRACT

The present invention provides a method and a system of providing assistance to a user to identify at least one context while forming a search query. In one embodiment, this is accomplished by receiving one or more inputs related to the search query, and providing a plurality of contexts related to the received input, wherein the contexts include one or more topics, and wherein the topics are part of one or more ontologies.

### CROSS-REFERENCE TO RELATED APPLICATIONS

The present application claims priority from the Indian (IN) provisional patent application serial no. 3028/CHE/2010 filed on Oct. 13, 2010 and entitled “A system and method for assisting the user to select the context of a search and to display the contexts of search results” the content of which is herein incorporated by reference in its entirety.

### FIELD OF THE INVENTION

The invention relates generally to network and internet search. More particularly, the present invention relates to a method and a system for providing assistance to a user to identify one or more contexts while forming a search query.

### BACKGROUND OF THE INVENTION

There are large amount of data available in the present age of Information Technology. It is important for the user to get relevant information from this maze of data. Search engines play a major role in fetching relevant data in the form of links that point to relevant content. The user's search query forms a critical component in getting the relevant information using the search engines.

The user may not have a clear idea of the desired information due to the lack of knowledge. In this case, the user has to try various search queries and go through the search results before getting the relevant information. The ambiguity related to the intended information has its negative impact on the quality of search results.

The user also faces a problem due to lack of expertise in a particular field in spite of being clear about the intended information. The formation of appropriate search query also depends on the expertise level of the user. It is quite difficult for the novice user, who is not aware of related words, to come up with appropriate search query.

The user, who is clear about the intended information and also well-informed, also faces a problem related to the context of the intended information. The richness of data and the language used to communicate the semantic understanding by humans offer a nice example where a single word may mean different things depending upon various contexts. In this case, the user is facing the problem in forming the search query related to the right context of the intended information.

For the reasons stated above, which will become apparent to those skilled in the art upon reading and understanding the present specification, there is a need in the art for a method and a system of providing assistance to a user to identify one or more contexts while forming a search query.

### SUMMARY OF THE INVENTION

This summary is provided to introduce a selection of concepts in a simplified form that are further described below in the Detailed Description. This summary is not intended to identify key features of the claimed subject matter, nor is it intended to be used as an aid in determining the scope of the claimed subject matter.

According to one aspect of the invention, there is provided a method of providing assistance to a user to identify at least one context while forming a search query, the method including receiving an input related to the search query, and providing a plurality of contexts related to the received input, wherein the contexts include one or more topics, and wherein the topics are part of one or more ontologies.

According to another aspect of the invention, there is provided a method of providing assistance to a user to identify at least one context while forming a search query, the method including receiving an input related to the search query, providing a plurality of contexts related to the received input, wherein the contexts include one or more topics, and wherein the topics are part of one or more ontologies, displaying a part of one or more ontologies related to one or more of the topics in a graphical region and allowing the user to navigate through the displayed graphical region to select a topic, wherein the topic is part of an ontology.

In another aspect, the invention includes a system of providing assistance to a user to identify one or more contexts while forming a search query, the system including one or more communication networks, a plurality of user devices connected to the communication network, and at least one server coupled to a data store, the server comprising a content extractor and a context module, wherein the server is capable of communicating with the plurality of user devices via at least one communication network, the server is configured for receiving an input related to the search query, providing a plurality of contexts related to the received input, wherein the contexts include one or more topics, and wherein the topics are part of one or more ontologies, displaying a part of one or more ontologies related to one or more of the topics in a graphical region and allowing the user to navigate through the displayed graphical region to select a topic, wherein the topic is part of an ontology.

In another aspect, the invention provides a machine-readable medium having stored thereon machine-executable instructions that if executed by a machine cause the machine to perform a method of providing assistance to a user to identify at least one context while forming a search query, the method including receiving an input related to the search query and providing a plurality of contexts related to the received input, wherein the contexts include one or more topics, and wherein the topics are part of one or more ontologies.

In another aspect, the invention provides a machine-readable medium having stored thereon machine-executable instructions that if executed by a machine cause the machine to perform a method of providing assistance to a user to identify at least one context while forming a search query, the method including receiving an input related to the search query, providing a plurality of contexts related to the received input, wherein the contexts include one or more topics, and wherein the topics are part of one or more ontologies, displaying a part of one or more ontologies related to one or more of the topics in a graphical region and allowing the user to navigate through the displayed graphical region to select a topic, wherein the topic is part of an ontology.

Additional advantages and features of the present invention will be more apparent from the detailed description and accompanying drawings, which illustrate preferred embodiments of the invention.

### BRIEF DESCRIPTION OF THE DRAWINGS

FIG. 1 shows a first aspect of an exemplary user interface to identify one or more contexts while forming a search query according to one embodiment of the present invention.

FIG. 2 shows a second aspect of an exemplary user interface to identify one or more contexts while forming a search query according to one embodiment of the present invention.

FIG. 3 shows a third aspect of an exemplary user interface to identify one or more contexts while forming a search query according to one embodiment of the present invention.

FIG. 4 shows an exemplary user interface of one or more contexts while forming a search query according to one embodiment of the present invention.

FIG. 5 illustrates an example method of providing assistance to a user to identify one or more contexts while forming a search query according to an exemplary embodiment of the present invention.

FIG. 6 illustrates a system of providing assistance to a user to identify at least one context while forming a search query according to an exemplary embodiment of the present invention.

FIG. 7 illustrates an example of a suitable computing environment of the method of providing assistance to a user to identify one or more contexts while forming a search query that may be fully or partially implemented.

### DETAILED DESCRIPTION OF THE INVENTION

In the following detailed description of the preferred embodiments, reference is made to the accompanying drawings that form a part hereof, and in which are shown by way of illustration specific embodiments in which the invention may be practiced. It is understood that other embodiments may be utilized and structural changes may be made without departing from the scope of the present invention.

The leading digit(s) of reference numbers appearing in the Figures generally corresponds to the Figure number in which that component is first introduced, such that the same reference number is used throughout to refer to an identical component which appears in multiple Figures.

The features, structures, or characteristics of the invention described throughout this specification may be combined in any suitable manner in one or more embodiments. For example, reference throughout this specification to “certain embodiments,” “some embodiments,” or similar language means that a particular feature, structure, or characteristic described in connection with the embodiment is included in at least one embodiment of the present invention. Thus, appearances of the phrases “in certain embodiments,” “in demonstrative embodiments,” “in some embodiment,” “in other embodiments,” or similar language throughout this specification do not necessarily all refer to the same group of embodiments and the described features, structures, or characteristics may be combined in any suitable manner in one or more embodiments.

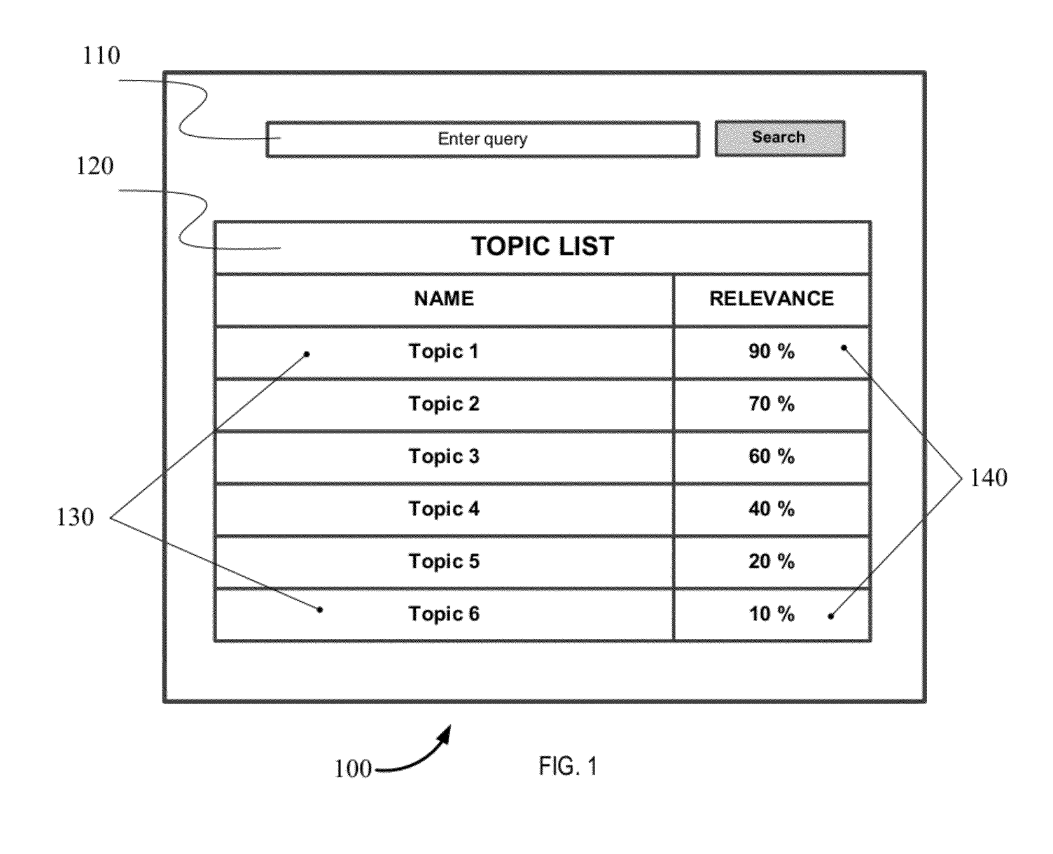

FIG. 1 shows a first aspect of an exemplary user interface to identify one or more contexts while forming a search query according to one embodiment of the present invention. FIG. 1 illustrates a User Interface 100 includes query window 110 and a topic window 120. The query window is capable of accepting one or more query strings or query sequences from one or more users. The topic window 120 is capable of displaying contexts related to the received query string or query sequence. Further, the topic window 120 includes a topic section 130 and a relevance ranking section 140. As soon as the system receives an input in the query window 110, the system is capable of displaying a plurality of contexts related to the received query before clicking the search button. The context may be or may include topics and topic relation, where the topics and topic relations are based on underlying domain ontologies. The domain may include a subject matter topic such as, for example, a disease, an organism, a drug, or other topic. The domain may also include one or more entities such as, for example, a person or group of people, a corporation, a governmental entity, or other entities. The domain involving an organization may focus on the organization's activities. For example, a pharmaceutical company may produce numerous drugs or focus on treating numerous diseases. The ontology built on the domain of that pharmaceutical company may include information on the company's drugs, their target diseases, or both. The domain may also include an entire industry such as, for example, automobile production, pharmaceuticals, legal services, or other industries. Other types of domains may be used.

In an example, the system displays a plurality of contexts, where the contexts may be or may include topics and topic relations. Once the topics are displayed in the topic window 120, the user is allowed to select topic or topics. After the selection of topic or topics, where the selected topic or topics are the intended contexts of information of the user, the user is allowed to click the search button to get the preferred results. In addition, the topics are shown with respect to the relevancy ranking in a descending order.

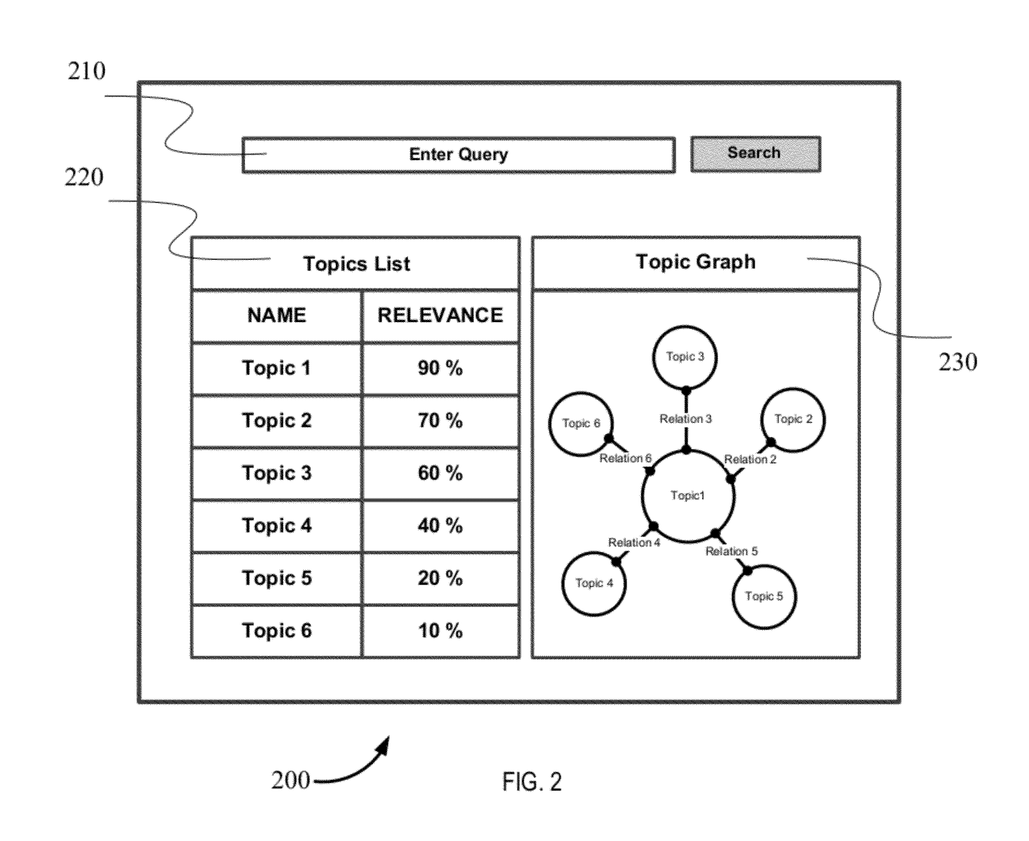

FIG. 2 shows a second aspect of an exemplary user interface to identify one or more contexts while forming a search query according to one embodiment of the present invention. FIG. 2 illustrates a User Interface that includes query window 210, a topic window 220 and a graph window 230. The query window is capable of accepting one or more query strings or query sequences from one or more users. The topic window 220 is capable of displaying contexts related to the received query string or query sequence. In the graph window 230, the displayed contexts in the topic window 220 are shown in a graphical representation which is also a part of the underlying ontology.

According to an embodiment of the invention, a user may familiarize himself about his intention of the search by seeing the graphical representation of the query contexts and their relations. This graphical representation view of the contexts and their relation allows the user to navigate to retrieve his actual query which the user is looking for. In addition, the plurality of contexts and their relation are shown with the relevancy ranking with respect to the entered query by the user. In one example embodiment, the graphical representation is shown in a topology having a root context and all sub-contexts are connected to the root context. The connection between all the other nodes with respect to root node is directly descending from the root node. The root node shown in the graphical representation has the highest relevancy rank and other nodes are descendents of the main root node.

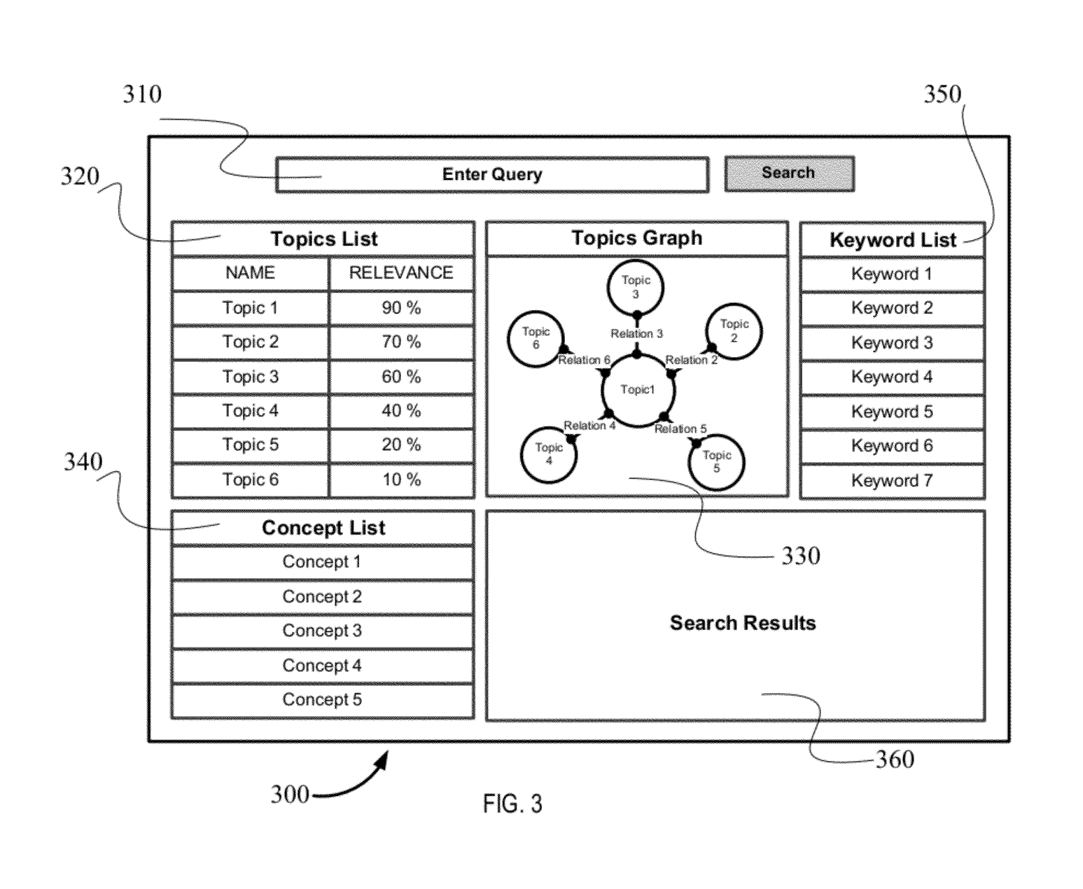

FIG. 3 shows a third aspect of an exemplary user interface to identify one or more contexts while forming a search query according to one embodiment of the present invention. FIG. 3 illustrates the User Interface that includes query window 310, a topic window 320, a graph window 330, a concepts window 340, a keyword window 350 and a search results window 360. The query window is capable of accepting one or more query strings or query sequences from one or more users. The topic window 320 is capable of displaying contexts related to the received query string or query sequence. As soon as the system receives input in the query window 310, the system is capable of displaying a plurality of contexts related to the received query before clicking the search button. The context may be or may include topics and topic relation, where the topics and topic relations are based on underlying domain ontologies. In the graph window 330, the displayed contexts in the topic window 320 are shown in a graphical representation which is also a part of the underlying ontology.

Further, the system is capable of generating one or more concepts and one or more keywords related to the received query string or query sequence. The concepts and keyword are displayed in their respective windows i.e. concept window 340 and keyword window 350. The displayed concepts are based on semantic proximity and the displayed keywords are based on the words available in the domain.

The system is capable of displaying all the windows simultaneously as soon as the query window receives one or more inputs. By displaying all the windows with different options, the user is capable of identifying one or more contexts and their relationships, one or more concepts, and one or more keywords while forming a search query. In addition to this, there is also possibility of having a provision for adding a keyword with the help of a tab (not shown in figures) or removing a keyword or a concept from their respective windows.

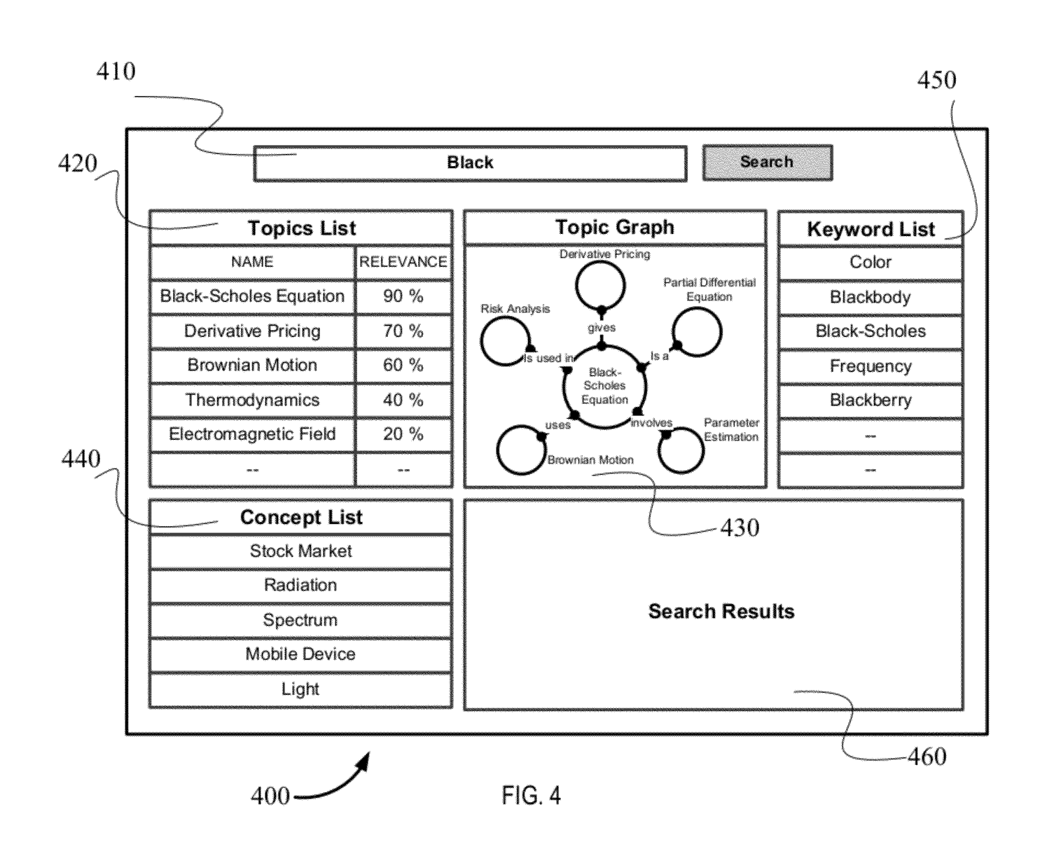

FIG. 4 shows an exemplary user interface of one or more contexts while forming a search query according to one embodiment of the present invention. FIG. 4 illustrates the User Interface that includes query window 410, a topic window 420, a graph window 430, a concepts window 440, a keyword window 450 and a search results window 460. In one example embodiment, the query window is capable of accepting query string or query sequence (example: ‘Black’) from a user. Based on the input, the topic window 420 displays a plurality of contexts or topics i.e. Black-Scholes Equation, Derivative Pricing, Brownian Motion, Thermodynamics, Electromagnetic Field, etc. All the displayed topics under the topic window 420 underlying domain ontologies which include topics and their relations in respect of query input i.e. ‘Black’. The first three topics belong to financial domain ontology and the last two belong to Physics Ontology. In the graph window 430, the displayed contexts in the topic window 420 i.e. topic and topic relation are shown in a graphical representation which is also a part of the underlying ontology as shown in FIG. 4. In an example display, the root node or central node is a Black-Scholes Equation and all the branch nodes are Derivative Pricing, Brownian Motion, Risk Analysis, and Parameter Estimation. The relations between the central node and the branch nodes discloses Black-Scholes Equation models uncertainty in the form of Brownian Motion, Black-Scholes Equation is used in Risk Analysis, Black-Scholes Equation whose solution gives Derivative Pricing, Black-Scholes Equation modeling involves Parameter Estimation etc.

In addition to these, the system generates one or more concepts and one or more keywords related to the received query ‘Black’. The concepts and keyword are displayed in their respective windows i.e. concept window 440 and keyword window 450. In an example, the concepts related to the query word ‘Black’ are stock market, radiation, spectrum, mobile device light etc. The displayed concepts are based on semantic proximity of the query word ‘Black’. The keywords related to the query are color, black body, Black-Scholes, frequency, blackberry etc. The displayed keywords are based on the words available in the domain.

The system by generating various options in the interface allows the user to choose or select one or more contexts, one or more concepts, and one or more keywords while forming a search query before conducting the search by clicking the search button.

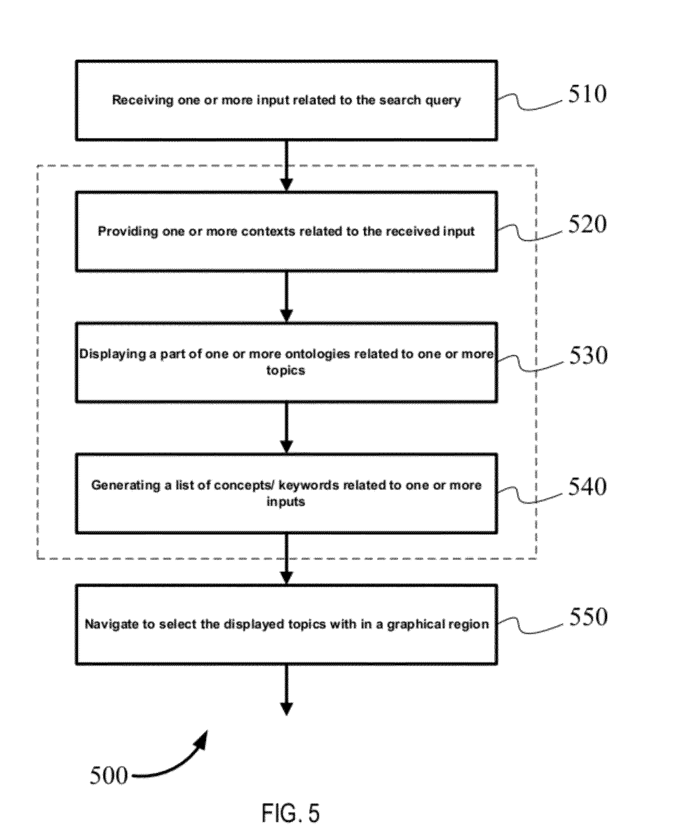

FIG. 5 illustrates an example method of providing assistance to a user to identify one or more contexts while forming a search query according to an exemplary embodiment of the present invention. In an operation, the method 500 at step 510 may accept one or more search strings from a user. In some embodiment, the method 500 may accept one or more search strings of a plurality of languages. In other embodiment, the method 500 may one or more search strings of one or more expressions (e.g. mathematical expression) of characters. In one embodiment, the input may be or may include one or more terms, one or more documents, or one or more Uniform Resource Locators (URLs).

At step 520, the method is capable of providing one or more contexts related to the received input. The contexts include one or more topics, and wherein the topics are part of one or more ontologies. In addition to these, providing one or more concepts is based on the relevance ranking that matches the received input. The one or more ontologies include a plurality of assertions with each assertion comprising a first topic, a second topic and a relationship between the first topic and the second topic.

At step 530, the method displays a part of one or more ontologies related to one or more of the topics in a graphical representation. The displaying one or more ontologies is in a two-dimensional or three-dimensional representation, where the representation includes one of the charts, topologies, graphs, etc.

At step 540, the method generates a list of concepts and keywords related to received input. The concepts are based on semantic proximity of the received input. The keyword may be or may include one or more synonyms, one or more antonyms, spelling correction, punctuations, auto completion or any other related meaning of the input.

At step 550, the method allows the user to navigate in any of the displayed window for selecting the desired or intended information. Particularly, the method allows the user to navigate in the graph window to select a topic or topics or allowing the user to traverse between the topics and their relations to retrieve his actual query term which the user is looking for.

Although the flowchart 500 includes steps 510-550 that are arranged serially in the exemplary embodiments, other embodiments of the subject matter may execute two or more steps in parallel, using multiple processors or a single processor organized as two or more virtual machines or sub-processors. Moreover, still other embodiments may implement the steps as two or more specific interconnected hardware modules with related control and data signals communicated between and through the modules, or as portions of an application-specific integrated circuit. Thus, the exemplary process flow diagrams are applicable to software, firmware, and/or hardware implementations.

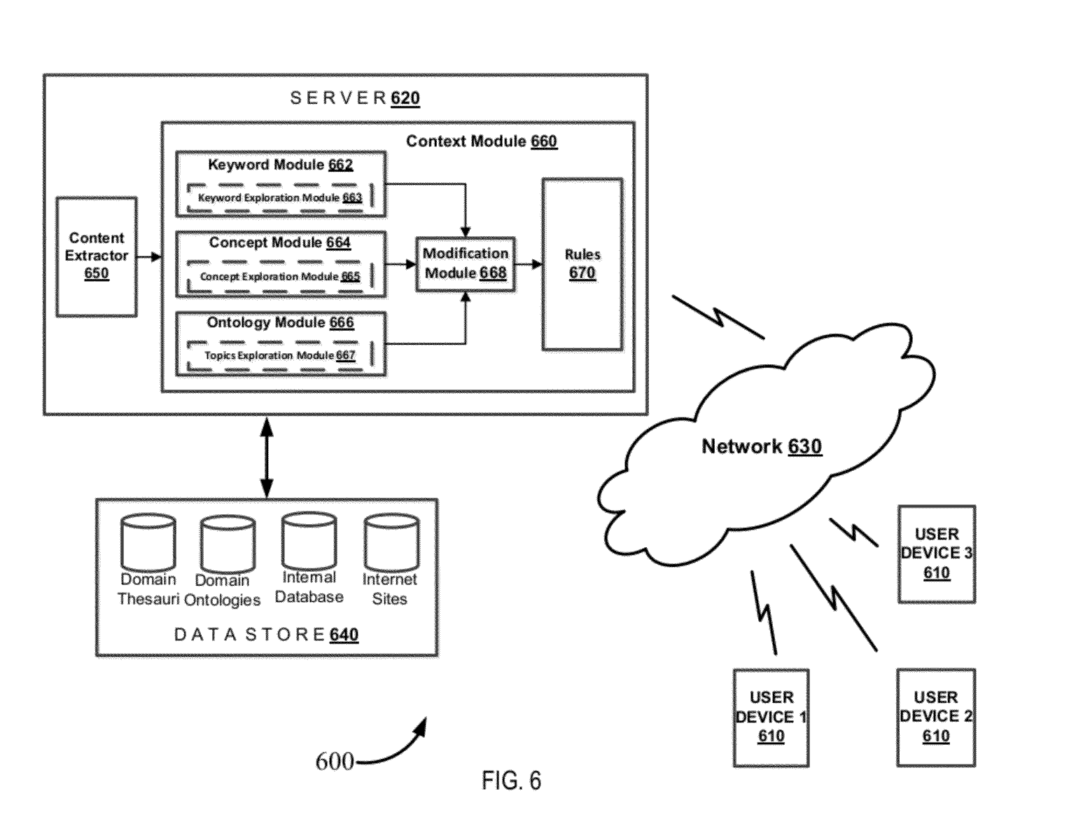

FIG. 6 illustrates a system of providing assistance to a user to identify at least one context while forming a search query according to an exemplary embodiment of the present invention. The system 600 includes one or more user devices 610, one or more servers 620 and one or more communication networks 630. The user device 610 may be or may include personal computer, mobile device, laptop and the device like. The server 620 may be or may include, for example, a handheld device, a computing device, a computer, a mobile computer, a portable computer, a laptop computer, a handheld computer, a handheld device, a PDA device, a handheld PDA device, a mobile or portable device, or the like. According to some aspects, the server 620 may comprise an interface (not shown in figure) connectable to one of the other devices/network via a wired or wireless connection. The communication network 630 may be or may include one or more networks selected from a group of networks consisting of a local area network, a metropolitan area network, a wide area network, a ring network and the like.

The server 620 further includes or coupled to a data store 640. In one form of data store is a database designed to integrate data from multiple sources for additional operations on the data. The data store 640 may include but not limited to domain thesauri, domain ontology, internal database, and internet sites.

The server 620 further includes a content extractor 650 and a context module 660. The context module 660 further includes a keyword module 662, a concept module 664 and an ontology module 666. The content extractor 650 is capable of extracting the content from the received input from one or more user input devices 610 through a communication network 630. The received input may include but not limited to terms, documents or URLs etc. The context module 660 is capable of processing the received input from the content extractor 650, and further coupled to data store 640 to provide or generate keyword list, concept list, topics and their relations.

The keyword module 662 has a keyword exploration module 663 which is capable receiving the keyword list provided by the keyword module 662 as input and allows the user to navigate through other keywords related to one or more of the input keywords in the displayed graphical region. The concept module 664 has a concept exploration module 665 which is capable of receiving the concept list provided by the concepts module 664 as input and allows the user to navigate through other concepts related to one or more of the input concepts in the displayed graphical region. The ontology module 666 has a topic exploration module 667 which is capable of receiving the topics and relations lists provided by the ontology module 666 as input and allows the user to navigate through other topics related to one or more of the input topics in the displayed graphical region. All the outputs of three modules i.e. keyword exploration module, concepts module and the topic exploration module are further processed by the modification module 668 which receives as input as graphs of keywords, concepts and topics, and allows the user to select a set of keywords, concepts and topics from the displayed graphical regions. In addition to this, the modification module allows the user to add new keywords, concepts and topics.

The system 600 further includes a rules module 670 which defines the rules for the search. The rules can be specified and stored in the system or given as input by the user. Rules may be or may include specifying the proximity of two terms in the search, allotting different weightage for different fields in the extracted content etc.

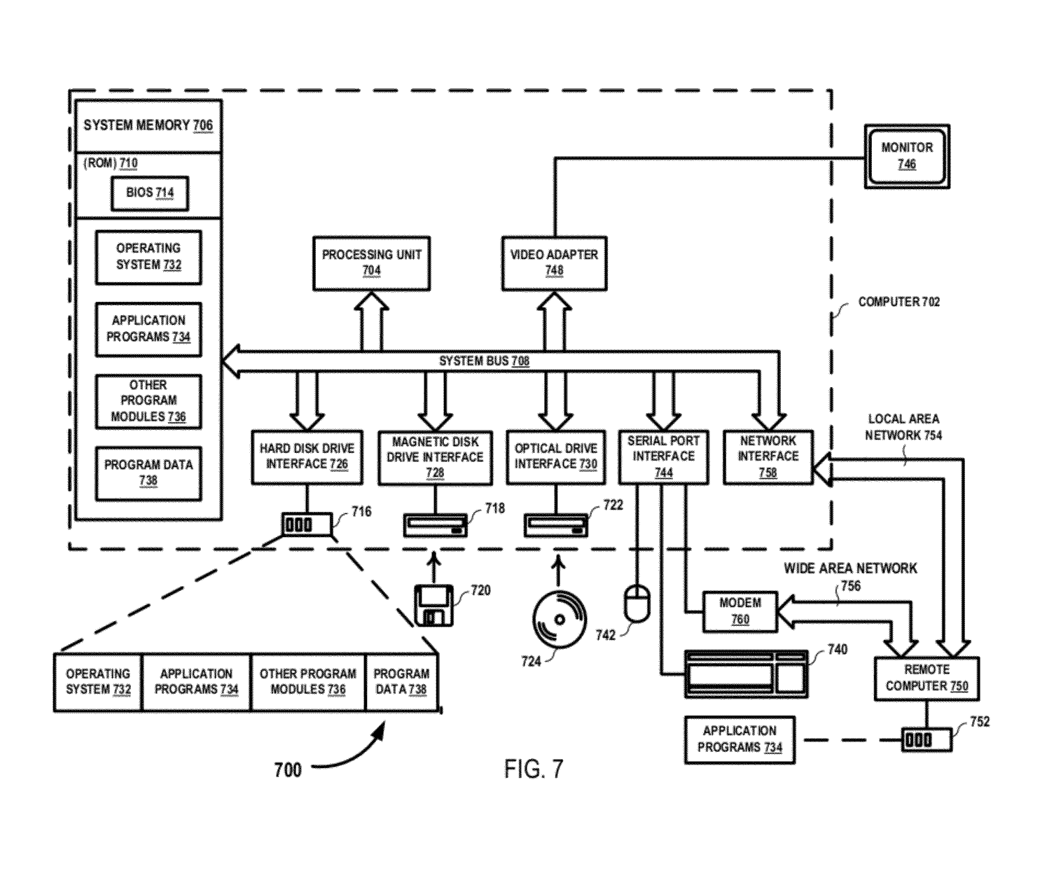

FIG. 7 illustrates an example of a suitable computing environment for a method of providing assistance to a user to identify at least one context while forming a search query that may be fully or partially implemented. Exemplary computing environment is only one example of a suitable computing environment for the exemplary system of FIG. 1-6 and is not intended to suggest any limitation as to the scope of use or functionality of the systems and methods described herein. Neither should computing environment be interpreted as having any dependency or requirement relating to any one or combination of components illustrated in computing environment.

The methods and systems described herein are operational with numerous other general purpose or special purpose computing system, environments or configurations. Examples of well-known computing systems, environments, and/or configurations that may be suitable for use include, but are not limited to, personal computers, server computers, multiprocessor systems, microprocessor-based systems, network PCs, minicomputers, mainframe computers, distributed computing environments that include any of the above systems or devices, and so on. Compact or subset versions of the framework may also be implemented in clients of limited resources, such as handheld computers, or other computing devices. The invention is practiced in a distributed computing environment where tasks are performed by remote processing devices that are linked through a communications network. In a distributed computing environment, program modules may be located in both local and remote memory storage devices.

With reference to FIG. 7, an exemplary system 700 of providing assistance to a user to identify at least one context while forming a search query includes a general purpose computing device in the form of a computer implementing, for example, system and/or method of FIG. 1-6. The following described aspects of computer are exemplary implementations of client computing device. Components of computer 702 may include, but are not limited to, processing unit(s) 704, a system memory 706, and a system bus 708 that couples various system components including the system memory to the processing unit(s) 704. The system bus 708 may be any of several types of bus structures including a memory bus or memory controller, a peripheral bus, and a local bus using any of a variety of bus architectures. By way of example and not limitation, such architectures may include Industry Standard Architecture (ISA) bus, Micro Channel Architecture (MCA) bus, Enhanced ISA (EISA) bus, Video Electronics Standards Association (VESA) local bus, Peripheral Component Interconnect (PCI) bus also known as Mezzanine bus, etc.

A computer 702 typically includes a variety of computer-readable media. Computer-readable media can be any available media that can be accessed by computer 702 and includes both volatile and nonvolatile media, removable and non-removable media. By way of example, and not limitation, computer-readable media may comprise computer storage media and communication media. Computer storage media includes volatile and nonvolatile, removable and non-removable media implemented in any method or technology for storage of information such as computer-readable instructions, data structures, program modules, or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computer 702.

Communication media typically embodies computer-readable instructions, data structures, or program modules, and includes any information delivery media. Combinations of the any of the above should also be included within the scope of computer-readable media.

System memory 706 includes computer storage media in the form of volatile and/or nonvolatile memory such as read only memory (ROM) 710 and random access memory (RAM). A basic input/output system (BIOS) 714, containing the basic routines that help to transfer information between elements within computer, such as during start-up, is typically stored in ROM; RAM typically contains data and/or program modules that are immediately accessible to and/or presently being operated on by processing unit. By way of example and not limitation, FIG. 7 illustrates operating system 732, application programs 734, other program modules 736, and program data 738.

The computer 702 may also include other removable/non-removable, volatile/nonvolatile computer storage media. By way of example only, FIG. 7 illustrates a hard disk 716 drive that reads from or writes to non-removable, nonvolatile magnetic media, a magnetic disk drive 718 that reads from or writes to a removable, nonvolatile magnetic disk 720, and an optical disk drive 722 that reads from or writes to a removable, nonvolatile optical disk such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 716 is typically connected to the system bus 708 through a non-removable memory interface such as interface 726, and magnetic disk drive 718 and optical disk drive 722 are typically connected to the system bus 708 by a removable memory interface, such as interface 728.

The drives and their associated computer storage media discussed above and illustrated in FIG. 7, provide storage of computer-readable instructions, data structures, program modules, and other data for the computer 702. In FIG. 7, for example, hard disk drive 716 is illustrated as storing operating system 732, application programs 734, other program modules 736, and program data 738. Note that these components can either be the same as or different from operating system 732, application programs 734, other program modules 736, and program data 738. Application programs includes, application programs, other program modules, and program data are given different numbers here to illustrate that they are at least different copies.

In one implementation, a user may enter commands and information into the computer 702 through input devices such as a keyboard 740 and pointing device 742, commonly referred to as a mouse, trackball, or touch pad. Other input devices (not shown) may include a microphone, joystick, game pad, satellite dish, scanner, or the like. These and other input devices are often connected to the processing unit 704 through a user input interface 744 that is coupled to the system bus, but may be connected by other interface and bus structures, such as a parallel port, game port, 1394/Fire wire, accelerated graphics port, or a universal serial bus (USB).

The computer operates in a networked environment using logical connections to one or more remote computers, such as a remote computer 702. The remote computer may be a personal computer, a server, a router, a network PC, a mobile computing device, a peer device, or other common network node, and as a function of its particular implementation, may include many or all of the elements described above relative to the computer 702, although only a memory storage device 752 has been illustrated in FIG. 7. The logical connections depicted in FIG. 7 include a local area network (LAN) 754 and a wide area network (WAN) 756, but may also include other networks. Such networking environments are commonplace in offices, enterprise-wide computer networks, intranets, and the Internet.

When used in a LAN networking environment, the computer 702 is connected to the LAN 734 through a network interface or adapter. When used in a WAN networking environment, the computer 702 typically includes a modem 760 or other means for establishing communications over the WAN 756, such as the Internet. The modem 760, which may be internal or external, may be connected to the system bus 708 via the user input interface 744, or other appropriate mechanism. In a networked environment, program modules depicted relative to the computer, or portions thereof, may be stored in the remote memory storage device. By way of example and not limitation, FIG. 7 illustrates remote application programs 734 as residing on memory device 752. The network connections shown are exemplary and other means of establishing a communications link between the computers may be used.

The present disclosure may be implemented with a variety of combination of hardware and software. If implemented as a computer-implemented apparatus, the present disclosure is implemented using means for performing all of the steps and functions described above.

The present disclosure can be included in an article of manufacture (e.g., one or more computer program products) having, for instance, computer usable media. The media has embodied therein, for instance, computer readable program code means for providing and facilitating the mechanisms of the present invention. The article of manufacture can be included as part of a computer system or sold separately.

FIGS. 1-7 are merely representational and are not drawn to scale. Certain portions thereof may be exaggerated, while others may be minimized. FIGS. 1-7 illustrate various embodiments of the disclosed invention that can be understood and appropriately carried out by those of ordinary skill in the art.

In the foregoing detailed description of embodiments of the invention, various features are grouped together in a single embodiment for the purpose of streamlining the disclosure.

The present invention as described above helps the user by providing more details of the search results to select the most appropriate result from the list of results. The search results provided by the system have more details about the content of each result in addition to providing the relationship among the results. In addition, the present invention helps the user in summarizing the content of each retrieved document. Also, the present invention provides a graphical user interface for the user to easily navigate through the results and select the most relevant document from the results.

We claim:

1. A method of providing assistance to a user to identify at least one context while forming a search query, the method comprising:
receiving an input related to the search query; and
providing a plurality of contexts related to the received input, wherein the contexts include one or more topics, and wherein the topics are part of one or more ontologies.

2. The method of claim 1, wherein the input includes at least one term, document, or URL.

3. The method of claim 1, further comprising:
displaying a part of one or more ontologies related to one or more of the topics, wherein displaying a part of one or more ontologies related to one or more of the contexts are in a two-dimensional or three-dimensional representation.

4. The method of claim 1, further comprising:
generating a list of keywords related to the received input.

5. The method of claim 1, wherein the step of providing a plurality of contexts is based on the relevance ranking that matches the received input.

6. The method of claim 1, wherein one or more ontologies includes a plurality of assertions with each assertions comprising a first topic, a second topic and a relationship between the first topic and the second topic.

7. A method of providing assistance to a user to identify at least one context while forming a search query, the method comprising:
receiving an input related to the search query;
providing a plurality of contexts related to the received input, wherein the contexts include one or more topics, and wherein the topics are part of one or more ontologies;
displaying a part of one or more ontologies related to one or more of the topics in a graphical region; and
allowing the user to navigate through the displayed graphical region to select a topic, wherein the topic is part of an ontology.

8. The method of claim 7, wherein the input includes at least one term, document, or URL.

9. A system of providing assistance to a user to identify one or more contexts while forming a search query, the system comprising:
one or more communication networks;
a plurality of user devices connected to the communication network; and
at least one server coupled to a data store, the server comprising a content extractor and a context module, wherein the server is capable of communicating with the plurality of user devices via at least one communication network, the server is configured for
receiving an input related to the search query; and
providing a plurality of contexts related to the received input, wherein the contexts include one or more topics, and wherein the topics are part of one or more ontologies;
displaying a part of one or more ontologies related to one or more of the topics in a graphical region; and
allowing the user to navigate through the displayed graphical region to select a topic, wherein the topic is part of an ontology.

10. The system of claim 9, wherein the input includes at least one term, document, or URL.

11. The system of claim 9, further the server is configured for
displaying a part of one or more ontologies related to one or more of the topics.

12. The system of claim 9, further the server is configured for:
generating a list of keywords related to the received input.

13. The system of claim 9, wherein the data store comprising:
a domain thesauri; and
a domain ontology

14. The system of claim 9, wherein the content extractor is capable of extracting the content from the received input, wherein the input is in the form of queries, documents or URLs.

15. The system of claim 9, wherein the context module includes a keyword module, a concept module and an ontology module, and wherein the context module coupled to the content extractor and data store for processing the received input from the content extractor, provides or generates keyword list, concept list, topics and their relations.

16. A machine-readable medium having stored thereon machine-executable instructions that if executed by a machine cause the machine to perform the method of providing assistance to a user to identify at least one context while forming a search query, the method comprising:
receiving an input related to the search query; and
providing a plurality of contexts related to the received input, wherein the contexts include one or more topics, and wherein the topics are part of one or more ontologies.

17. The machine-readable medium of claim 16, wherein the input includes at least one term, document, or URL.

18. The machine-readable medium of claim 16, wherein the method further comprises displaying a part of one or more ontologies related to one or more of the topics.

19. The machine-readable medium of claim 16, wherein the method further comprises generating a list of keywords related to the received input.

20. The machine-readable medium of claim 16, wherein the step of providing a plurality of contexts is based on the relevance ranking that matches the received input.
